(19) United States
(12) Patent Application Publication
(10) Pub. No.: US 2011/0032208 A1
(43) Pub. Date: Feb. 10, 2011

(54) COMPLEX RESISTANCE TYPE COORDINATE INPUT DEVICE

(75) Inventor: CHIH-CHENG CHEN, Yuan Kang Industrial District (TW)

Correspondence Address: G. LINK CO., LTD., 2885 Sanford Ave SW #13265, Grandville, MI, 49418, US

(73) Assignee: SUPER ELITE TECHNOLOGY COMPANY LIMITED, Yuan Kang Industrial District (TW)

(21) Appl. No.: 12/787,993

(22) Filed: May 26, 2010

(30) Foreign Application Priority Data
Aug. 5, 2009 (TW) 098126353

(51) Int. Cl. G06F 3/045

(52) U.S. Cl. 345/174

(57) ABSTRACT

A complex resistance type coordinate input device includes an upper conductive structural layer, a lower conductive structural layer, and an intermediate conductive structural layer being disposed between the upper conductive structural layer and the lower conductive structural layer. The upper conductive structural layer provides an upper conductive thin layer, the lower conductive structural layer provides a lower conductive thin layer, and the intermediate conductive structural layer provides the first intermediate conductive thin layer facing the upper conductive thin layer and the second side of the intermediate conductive structural layer to form a digit-resistance type touch pad structure, and the second intermediate conductive thin layer facing the lower conductive thin layer to form an analog-resistance type touch pad structure.

### BACKGROUND OF THE INVENTION

1. Field of the Invention

The present invention is related to a complex resistance type coordinate input device, and particularly to a coordinate input device which combines the digit-resistance type touch pad structure and the analog-resistance type touch pad structure.

2. Brief Description of the Related Art

The conventional resistance type touch pad structure can be classified into the following types: ITO conductive film 11 to ITO conductive film 12 as shown in FIG. 1A (ITO is an abbreviation of Indium Tin Oxide), and it is simply called F-F type; ITO conductive film 11 to ITO conductive glass 13 as shown in FIGS. 1B and 1C, and it is simply called F-G type; ITO conductive glass 13 to IT( ) conductive glass 14 as shown in FIG. 1D, and it is simply called G-G type; ITO conductive film 11 to ITO conductive film 12 on PC 15 (PC is an abbreviation of polycarbonate) as shown in FIG. 1E, and it is simply called F-F-PC; ITO conductive film 11 to ITO conductive film on acrylic 16 as shown in FIG. 1F, and it is simply called F-F-PMMA type (PMMA is an abbreviation of polymethylmethacrylat, German terminology). It is noted that the cable 18 shown in FIGS. 1A to 1F is used for signal transmission. It can be seen the fragmentary view of the F-G type shown in FIG. 1C that the inner surfaces of the ITO conductive film 11 and the ITO conductive glass 13 are attached with ITO layers 111, 131 respectively. The resistance type touch pad is further classified into the digit-resistance type and the analog-resistance type depending on the way to fabricate the ITO layers. The structures of the digit-resistance type and the analog-resistance type touch pads are explained further hereinafter:

Referring to FIG. 2, the digit-resistance type touch pad structure provides an upper ITO conductive layer 211 with multiple vertical leads 2111 (along the direction of Y-axis) on the upper ITO structure layer 21, and a lower ITO conductive layer 221 with multiple horizontal leads 2211 (along the direction of X-axis) on the lower ITO structure layer 22. A micro processor is utilized to multi-scan the directions along Y-axis and X-axis sequentially; once a press point indicated by the arrows shown in the figure has been scanned by the micro processor, the coordinates corresponding to the position of the pressed point can be obtained.

Referring to FIG. 3, the analog-resistance type touch pad structure provides an upper ITO conductive layer 311 on the upper ITO structural layer 31 and a lower ITO conductive layer 321 on the lower ITO structural layer 32. The upper ITO conductive layer 311 has two parallel printed silver leads 3111, 3112 disposed next to two horizontal lateral sides of the upper ITO structural layer 31 respectively, and the two printed silver leads 3111, 3112 are electrically connected to the cable 313. The lower ITO conductive layer 321 has two parallel printed silver leads 3211, 3212 disposed next to two vertical lateral sides of the lower ITO structural layer 32, and the two silver leads 3211, 3212 are electrically connected to the cable 323. When a micro processor is utilized to send 5 volt and 0 volt voltages to the two printed silver leads 3111, 3112 of the upper ITO conductive layer 311 respectively at different time points to produce proportional voltage drops, the touch pad is pressed or contacted at the position indicated by the arrow on the upper ITO conductive structural layer 31 and a corresponding voltage value can be read out at the lower ITO conductive structural layer 32 at the same time. Then, the voltage value passes through an analog/digit converter for being operated by the micro processor such that X-coordinate and Y-coordinate corresponding to the voltage value can be obtained. By the same token, the micro processor can send the preceding two voltages to the two printed silver leads 3211, 3212 of the lower ITO conductive layer 321, and the corresponding X-coordinate and Y-coordinate of the position of the contact point can be obtained via the voltage value being read out at the upper ITO conductive structural layer 31. The preceding procedures for figuring out the corresponding X-coordinate and Y-coordinate of the position of the contact point can be operated repeatedly to verify the correctness of the corresponding X-coordinate and Y-coordinate of the position of the contact point.

Nevertheless, the previous conventional digit-resistance type touch pad structure and the analog-resistance type touch pad still have inevitable deficiencies such as the digit-resistance type touch pad structure having a disadvantage of insufficient resolution and the analog-resistance type touch pad structure having a problem relating to insufficient touch points. It is known that the resolution is a factor to influence the clearness of the touch pad and the analog-resistance type touch pad provides better resolution. But the single touch point results in inaccuracy when the analog-resistance type touch pad is operated.

### SUMMARY OF THE INVENTION

In order to overcome the deficiencies of the preceding prior art, an object of the present invention is to provide a complex resistance type coordinate input device which is completely new and different from the traditional resistance type touch pad to overcome the shortcomings of the conventional resistance type touch pad for easing the operation and providing accurate results.

Another object of the present invention is to provide a complex resistance type coordinate input device which combines the digit-resistance type and analog-resistance type touch pad structures for promoting performance the resistance type touch pad and being more conveniently operated by the user.

### BRIEF DESCRIPTION OF THE DRAWINGS

The detail structure, the applied principle, the function and the effectiveness of the present invention can be more fully understood with reference to the following description and accompanying drawings, in which:

FIGS. 1A to 1F are sectional views of the conventional F-F, F-G, G-G, F-F-PC and F-F-PMMA resistance type touch pads;

FIG. 2 is a perspective view illustrating the structure of the conventional digit-resistance type touch pad;

FIG. 3 is a perspective view illustrating the structure of the conventional analog-resistance type touch pad;

FIG. 4 is a sectional view illustrating the basic structure of a preferred embodiment of a complex resistance type coordinate input device according to the present invention;

FIG. 5 is a disassembled sectional view illustrating the detailed structure of the preferred embodiment of a complex resistance type coordinate input device according to the present invention;

FIG. 6 is a perspective view of the preferred embodiment shown in FIG. 5 illustrating the upper conductive structural layer and the intermediate dual conductive structural layer constituting the analog-resistance type structure; and

FIG. 7 is a perspective view of the preferred embodiment shown in FIG. 5 illustrating the upper conductive structural layer and the intermediate dual conductive structural layer constituting the analog-resistance type structure.

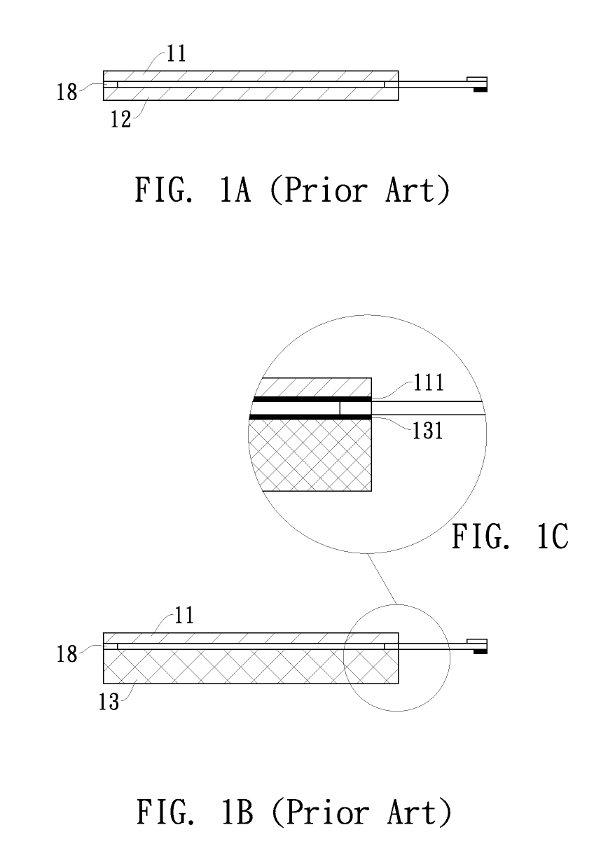

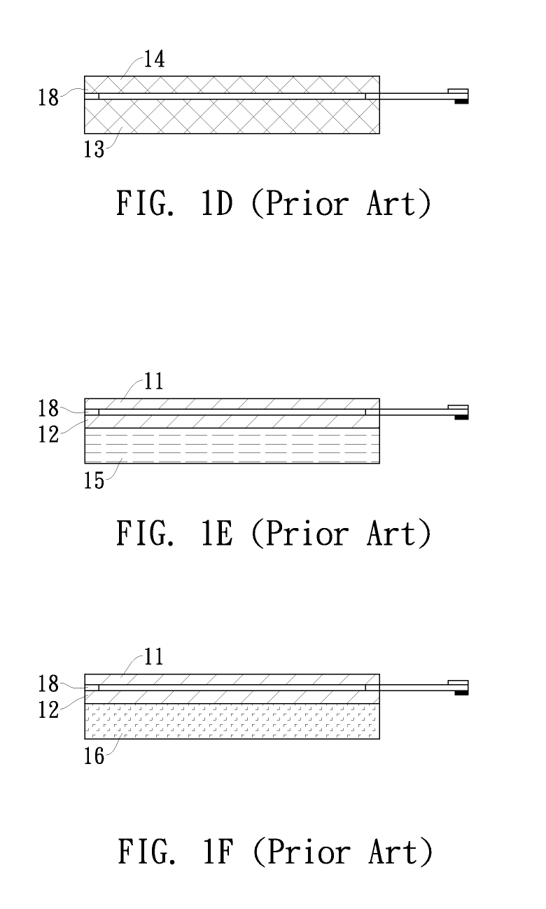

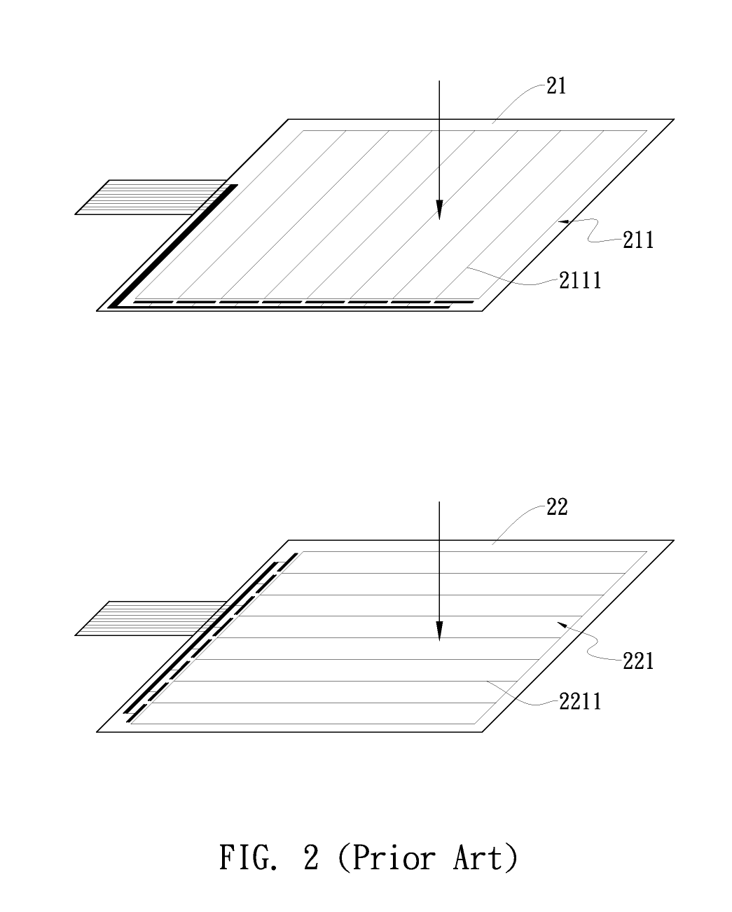

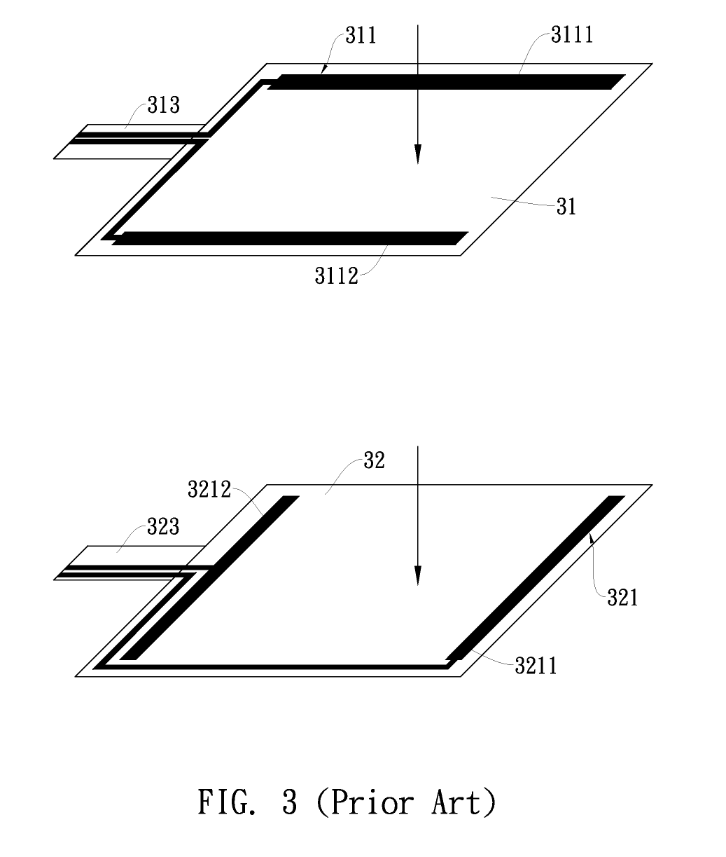

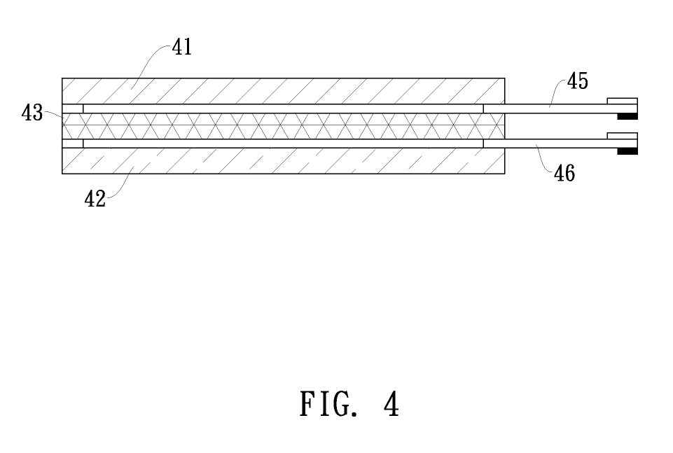

### DETAILED DESCRIPTION OF THE INVENTION

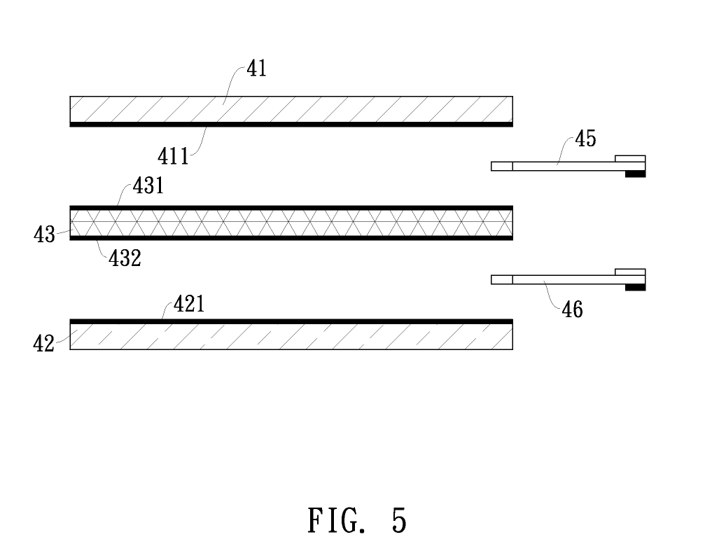

Referring to FIG. 4, the basic structure of a preferred embodiment of a complex resistance type coordinate input device according to the present invention is illustrated. The complex resistance type coordinate input device shown in FIG. 4 comprises an upper conductive structural layer 41, a lower conductive structural layer 42 and an intermediate double-conductive structural layer 43. The intermediate double-conductive structural layer 43 is disposed between the upper conductive structural layer 41 and the lower conductive structural layer 42. Besides, a spacer layer is respectively arranged between the upper conductive structural layer 41 and the intermediate double-conductive structural layer 43 and between lower conductive structural layer 42 and the intermediate double-conductive structural layer 43. Further, a first flat cable 45 is disposed at the spacer layer between the upper conductive structural layer 41 and the intermediate double-conductive structural layer 43, and a second flat cable 46 is disposed at the spacer layer between lower conductive structural layer 42 and the intermediate double-conductive structural layer 43 for performing the circuit transmission. The arrangement of the intermediate double-conductive structural layer 43 is utilized to form a touch pad device containing the digit-resistance type touch pad structure and the analog-resistance type touch pad structure. Referring to FIG. 5, the detailed arrangement of the preceding preferred embodiment is illustrated in addition to the structure shown in FIG. 4. The upper conductive structural layer 41 provides an upper transparent conductive thin layer 411 at a side facing the intermediate double-conductive structural layer 43, and the lower conductive structural layer 42 provides a lower transparent conductive thin layer 421 at a side facing the intermediate double-conductive structural layer 43 too. Further, the intermediate double-conductive structural layer 43 has a first transparent intermediate conductive thin layer 431 at a side facing and corresponding to the upper transparent conductive thin layer 411 and has a second intermediate transparent conductive thin layer 432 at a side facing and corresponding to the lower transparent conductive thin layer 421 such that the upper transparent conductive thin layer 411 and the first transparent intermediate conductive thin layer 431 can constitute a digit-resistance type touch pad structure, and the lower transparent conductive thin layer 421 and the second transparent intermediate conductive thin layer 431 can constitute an analog-resistance type touch pad structure. Alternatively, the upper transparent conductive thin layer 411 and the first transparent intermediate conductive thin layer 431 can constitute an analog-resistance type touch pad structure, and the lower transparent conductive thin layer 421 and the second transparent intermediate conductive thin layer 431 can constitute a digit-resistance type touch pad structure.

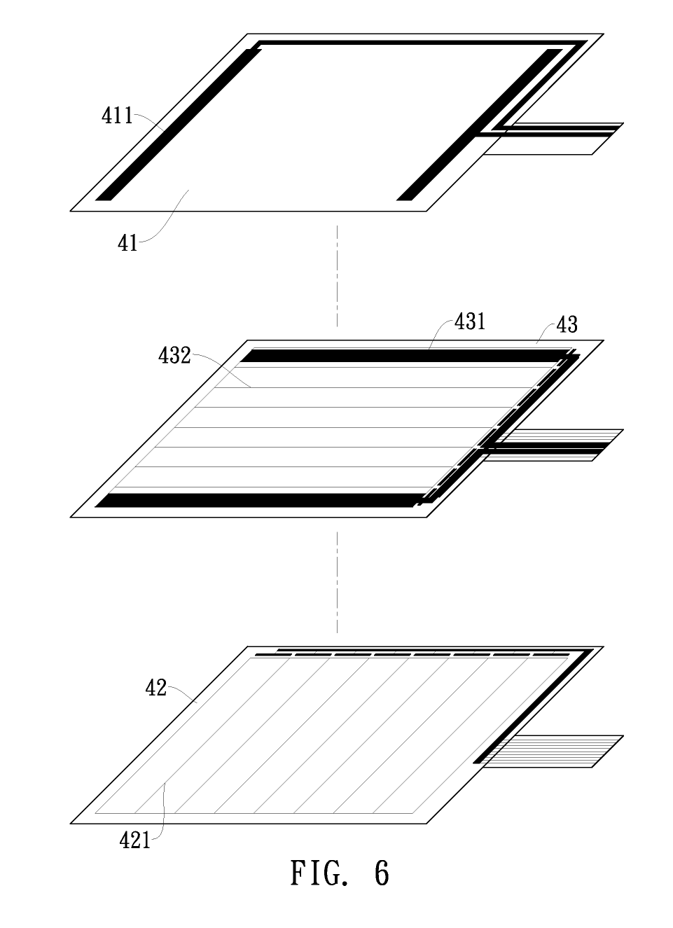

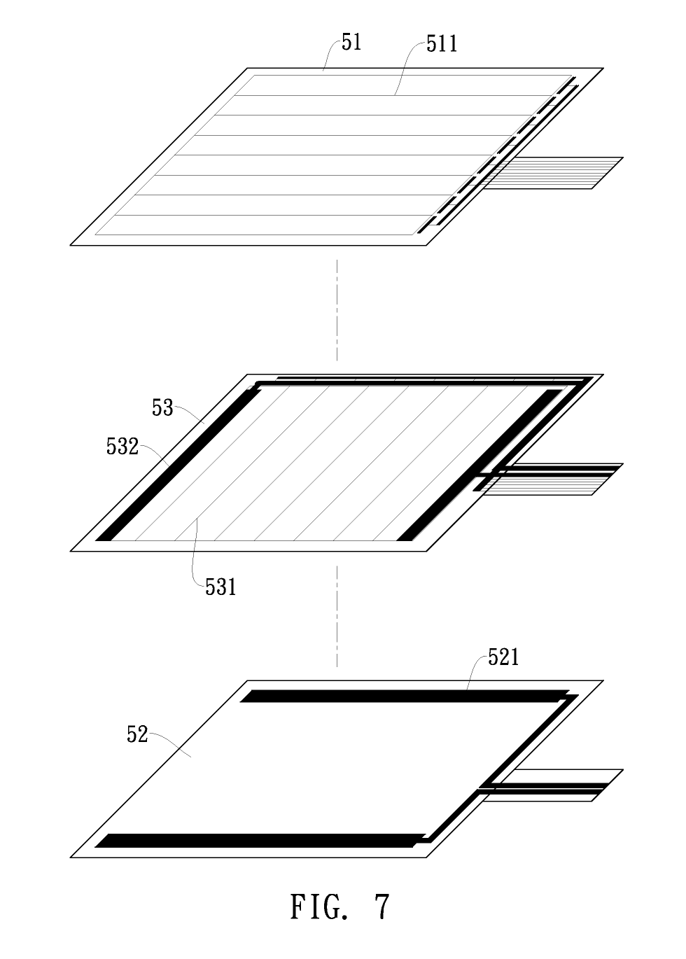

Referring to FIGS. 6 and 7, the perspective view shown in FIG. 6 is illustrated to show that the upper transparent conductive thin layer 411 disposed at the bottom of the upper conductive structural layer 41 and the first transparent intermediate conductive thin layer 431 disposed at the top of the intermediate double-conductive structural layer 43 constitute an analog-resistance type touch pad structure, and the lower transparent conductive thin layer 421 disposed at the top of the lower conductive structural layer 42 and the second transparent intermediate conductive thin layer 431 disposed at the bottom of the intermediate double-conductive structural layer 43 constitute a digit-resistance type touch pad structure; the perspective view shown in FIG. 7 is illustrated to show that the upper transparent conductive thin layer 511 disposed at the bottom of the upper conductive structural layer 51 and the first transparent intermediate conductive thin layer 531 disposed at the top of the intermediate double-conductive structural layer 53 constitute a digit-resistance type touch pad structure, and the lower transparent conductive thin layer 521 disposed at the top of the lower conductive structural layer 52 and the second transparent intermediate conductive thin layer 531 disposed at the bottom of the intermediate double-conductive structural layer 53 constitute an analog-resistance type touch pad structure.

As the foregoing, when the preceding complex resistance type coordinates input device according to the present invention is pressed, the coordinates of the pressed spot can be figured out accurately via the circuits of the digit-resistance type structure and the analog-resistance type structure. Therefore, the problem of insufficient single touch points can be solved and high resolution of the touch pad can be maintained as well such that the resistance type touch pad can be operated more conveniently and precisely.

While the invention has been described with referencing to the preferred embodiments thereof, it is to be understood that modifications or variations may be easily made without departing from the spirit of this invention which is defined by the appended claims.

What is claimed is:

1. A complex resistance type coordinate input device comprising:
an upper conductive structural layer with a lower side;
a lower conductive structural layer with an upper side;
an intermediate conductive structural layer being disposed between the upper conductive structural layer and the lower conductive structural layer, and having a first side and a second side opposite to each other;
wherein the lower side of the upper conductive structural layer provides an upper conductive thin layer, the upper side of the lower conductive structural layer provides a lower conductive thin layer, the first side of the intermediate conductive structural layer provides a first intermediate conductive thin layer facing the upper conductive thin layer and the second side of the intermediate conductive structural layer provides a second intermediate conductive thin layer facing the lower conductive thin layer to said first intermediate conductive thin layer such that the upper conductive thin layer and the first intermediate conductive thin layer constitute a digit-resistance type touch pad structure and the lower conductive thin layer and the second intermediate conductive thin layer constitute an analog-resistance type touch pad structure;
whereby when a spot of the upper conductive structural layer is pressed, coordinates of said pressed spot is obtained accurately via the digit-resistance type touch pad structure and the analog-resistance type touch pad structure.

2. A complex resistance type coordinate input device comprising:
an upper conductive structural layer with a lower side;
a lower conductive structural layer with an upper side;
an intermediate conductive structural layer being disposed between the upper conductive structural layer and the lower conductive structural layer, and having a first side and a second side opposite to each other;
wherein the lower side of the upper conductive structural layer provides an upper conductive thin layer, the upper side of the lower conductive structural layer provides a lower conductive thin layer, the first side of the intermediate conductive structural layer provides a first intermediate conductive thin layer facing the upper conductive thin layer and the second side of the intermediate conductive structural layer provides a second intermediate conductive thin layer facing the lower conductive thin layer to said first intermediate conductive thin layer such that the upper conductive thin layer and the first intermediate conductive thin layer constitute an analog-resistance type touch pad structure and the lower conductive thin layer and the second intermediate conductive thin layer constitute a digit-resistance type touch pad structure;
whereby when a spot of the upper conductive structural layer is pressed, coordinates of said pressed spot is obtained accurately via the analog-resistance type touch pad structure and the digit-resistance type touch pad structure.
